(19) United States
(12) Patent Application Publication
(10) Pub. No.: US 2008/0232926 A1
(43) Pub. Date: Sep. 25, 2008

(54) Screw

(76) Inventor: Tai-Ping Hsu, A Lien Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/723,783

(22) Filed: Mar. 22, 2007

(51) Int. Cl. F16B 35/04

(52) U.S. Cl. 411/412

(57) ABSTRACT

The present invention is in particular to a first threaded section and a second threaded section both consisted of a plurality of threads are spirally disposed on the shank and connecting each other. Moreover, said first threaded section is a continuous threaded section, and said second threaded section is a non-continuous threaded section. While in operation, with said first threaded screwing, the user can save more labor in screwing the present invention. Further accompanying with said non-continuous second threaded section, the debris cut from the object can be accumulated inside said second threaded section and connected together. Therefore, the present invention will be well fastened into the object after screwing.

### BACKGROUND OF THE INVENTION

1. Field of the Invention

The present invention relates to a screw design, particularly to a screw which is benefit at saving user's labor and fastening into the object.

2. Description of the Related Art

Referring to FIG. 1, a conventional screw 1 comprises a head 11, a shank 12 connecting to the head 11, and a first threaded section 13 and a second threaded section 14 spirally disposed on the shank 12; wherein, the shank 12 forms a drilling portion 121 thereon opposite to the said head 11; moreover, the first threaded section 13 and the second threaded section 14 are spirally disposed along the same direction and are interlaced; still further, the thread height of the first threaded section 13 exceeds the thread height of the second threaded section 14, a bigger pitch P1 is therefore formed between any two first threaded sections or any two second thread sections. Referring to FIG. 2, while the conventional screw 1 screws into a concrete object 2, the first threaded section 13 and the second threaded section 14 cut the concrete object 2, and the debris 21 cut from the concrete object 2 is accumulated inside the first threaded section 13 and the second threaded section 14 the conventional screw 1 be well fixed to the concrete object 2.

However, while in operation, the conventional screw 1 still has following shortcomings:
1. As described above, the first threaded section 13 and the second threaded section 14 are interlaced as a double-threaded type. While in operation, it is mainly to use the first threaded section 13 for screwing. However, because the pitch P1 is designed to be wider for containing more debris, the screwing angle of the first threaded section 13 enlarges. Therefore, the torque increases and the user had to spend more labor to screw. Moreover, if the first threaded section 13 is not firm enough to resist said torque, the first threaded section 13 may be broken and the operation will be affected.
2. The aforesaid double-threaded type makes the conventional screw 1 screw into the concrete object 2 in a wider angle, and the user can not hold the screwing tool easily and bestow his labor firmly. Therefore, the conventional screw 1 may rotate idly while screwing the drilling portion 121 into the concrete object 2. Moreover, the first threaded section 13 and the second threaded section 14 hence have the problem of reaming due to the situation of rotating idly. Therefore, the conventional screw 1 may not be well fastened to the concrete object 2 after screwing.
3. The conventional screw 1 takes advantage of the bigger pitch P1 formed between any two threaded first threaded section 13 and any two second threaded section 14 to provide a space for containing the debris, it hence can increase the effect of fastening into the concrete object 2 after screwing. However, the conventional screw 1 has the aforesaid reaming problem because of the effect on fastening; therefore, it still needs to be improved.

### SUMMARY OF THE INVENTION

It is therefore the purpose of this invention to provide a screw which is benefit at saving user's labor and is able to avoid the problem of reaming while in operation, further to fasten itself into a concrete object.

The screw in accordance with the present invention comprises a head, a shank connecting to said head, and a first threaded section and a second threaded section spirally disposed on said shank; wherein, said two threaded sections connect to each other; moreover, said first threaded section is a continuous threaded section, and said second threaded section is a non-continuous threaded section; furthermore, each thread of said second threaded section has a convex area and a concave area interlaced. While in operation, due to that said two threaded sections which is a single-threaded type, the user is capable of spending less labor on screwing. Moreover, the situation of holding the screwing tool hardly and being hard to firmly bestow the labor is able to be avoided, and the debris cut from the concrete object can be accumulated inside said second threaded section and connected together. Therefore, the present invention will be fastened into the concrete object after screwing.

The advantages of the present invention over the known prior art will become more apparent to those of ordinary skilled in the art upon reading the following descriptions in conjunction with the accompanying drawings.

### BRIEF DESCRIPTION OF THE DRAWINGS

FIG. 1 is a perspective view showing a conventional screw;

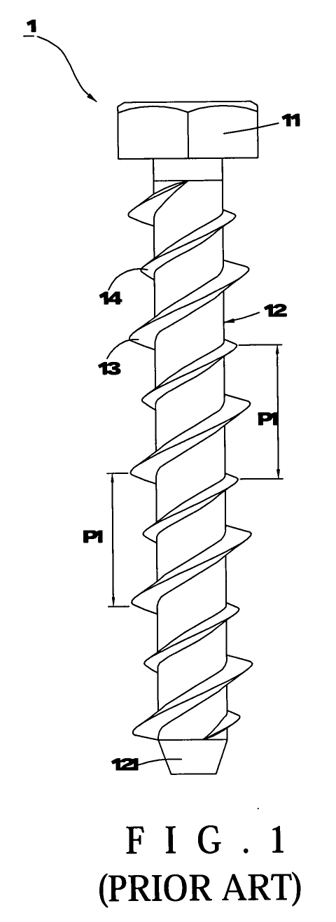

FIG. 2 is a schematic view showing said conventional screw screwing;

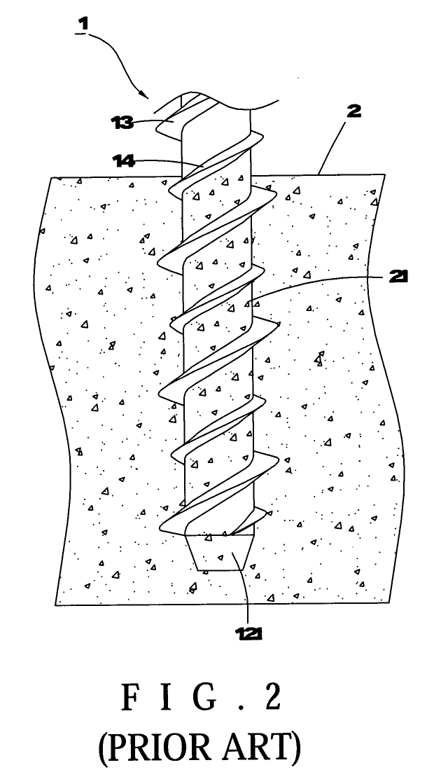

FIG. 3 is a perspective view showing the first preferred embodiment of the present invention;

FIG. 4 is a perspective view showing the second preferred embodiment of the present invention;

FIG. 5 is a schematic view showing said first preferred embodiment screwing; and

FIG. 6 is a schematic view showing the third preferred embodiment of the present invention.

### DETAILED DESCRIPTION OF THE PREFERRED EMBODIMENTS

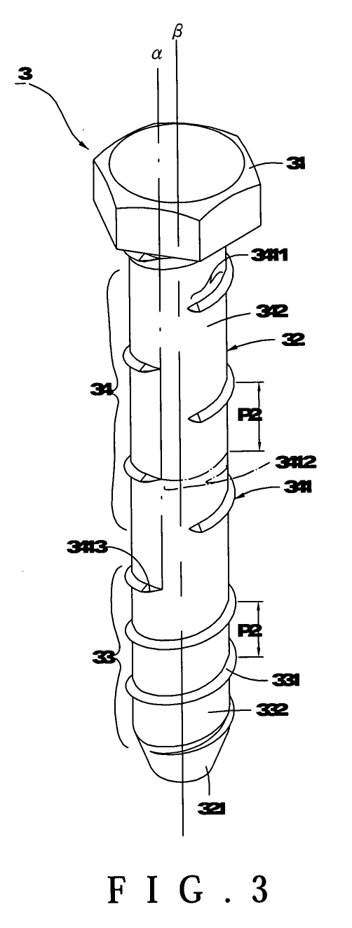

Referring to FIG. 3, the screw 3 of the first preferred embodiment comprises a head 31, a shank 32 connecting to the head 31, a first threaded section 33 and a second threaded section 34 spirally disposed on the shank 32; wherein, the shank 32 forms a drilling portion 321 thereon opposite to the head 31, and the drilling portion 321 can be a drilling member, a sharp point, or a narrowing shank. In this preferred embodiment, the drilling portion 321 is a gradually narrowing shank.

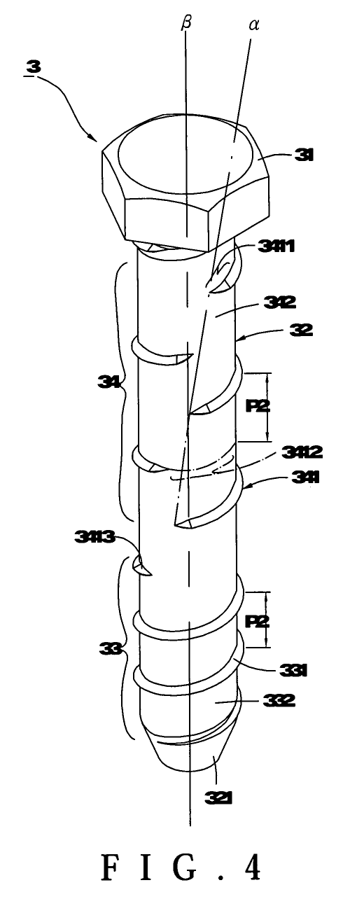

Continuing with the last paragraph, the first threaded section 33 and the second threaded section 34 are consisted of a plurality of threads 331, 341 respectively, and a plurality of valleys 332, 342 are formed between the adjacent threads 331, 341, and the width of each two valleys 332, 342 is a pitch P2. Moreover, the first threaded section 33 is disposed near the drilling portion 321 and is a continuous threaded section, and the second threaded section 34 is disposed near the head 31. Furthermore, the first threaded section 33 and the second threaded section 34 connect to each other. Therefore, the threads 331 of the first threaded section 33 and the threads 341 of the second threaded section 34 do not need to be spirally disposed on the shank 32 in a smooth inclined angle. Still further, the second threaded section 34 is a non-continuous threaded section, which means each thread 341 of the second threaded section 34 has a convex area 3411 and a concave area 3412 lower than the convex area 3411 interlaced, and each two adjacent valleys 342 connect to each other through the concave area 3412. Moreover, each convex area 3411 forms an inclined surface 3413 to contact the adjacent concave area 3412. Furthermore, in this preferred embodiment, the corresponding concave areas 3412 of the threads 341 of the second threaded section 34 are combined to form an imaging line α parallel with the central line β of the shank 32; the imaging line α is inclined to the central line β of the shank 32 as shown in FIG. 4, and in this preferred embodiment the parallel type is taken as an example.

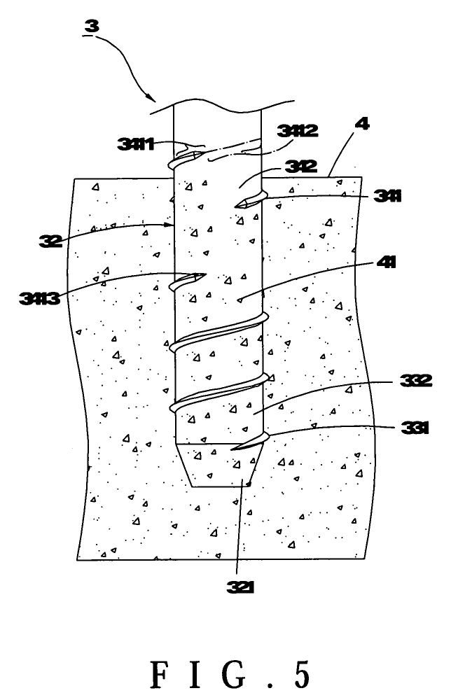

Referring to FIG. 5, while screwing into the concrete object 4, at first, the continuous threads 331 of the first threaded section 33 are used to cut, further accompanying with the threads 331 of the first threaded section 33 are not very inclined to the shank 32 and the debris formed by cutting smoothly obviated through the concave 3412, the user hence can save more labor and the screw 3 easily screwed into the concrete object 4. Relatively, the user can hold the screwing tool firmly and bestow the labor downward to the screw 3 vertically; therefore, the problem of reaming will not happen. Then, the second threaded section 34 screws into the concrete object 4 along the cutting track of the first threaded section 33. Meanwhile, the debris cut from the concrete object 4 can be accumulated inside the valleys 332, 342. Furthermore, because the second threaded section 34 is a non-continuous threaded section, said debris can be accumulated therein through the concave areas 3412 to connect in extensiveness and help the screw 3 fastened into the concrete object 4 firmly.

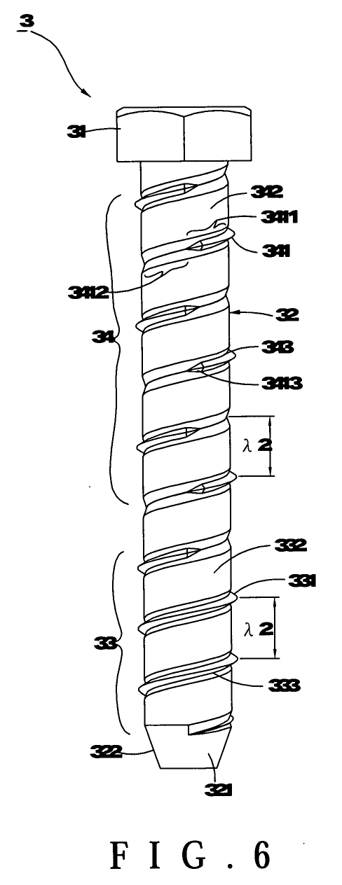

Referring to FIG. 6, this drawing shows the third preferred embodiment of the present invention, and most of its factors are the same as the screw 3 of the first preferred embodiment, which is in particular to two grooves 333, 343 respectively disposed beside the first threaded section 33 and the second threaded section 34, and said grooves 333 and 343 spirally disposed on the shank 32 connect to each other. While in operation, the grooves 333, 343 are benefit at obviating the debris. The debris cut by the first threaded section 33 and the second threaded section 34 can be obviated smoothly along the grooves 333, 343, and hence the grooves 333, 343 are benefit at screwing. Therefore, the screw 3 can be firmly screwed into the concrete object 4.

According to the prior description, and comparing the present invention and the conventional screw, we can find that the present invention certainly has the following advantages and efficacies:
1. Due to the threads of the first threaded section are not very inclined to the shank and the pitches of the present invention are smaller than the pitches of the conventional screw, the threads of the present invention are not as inclined as the threads of the conventional screw; furthermore accompanying with the non-continuous threads of the second threaded section for the benefit of obviating the debris and avoid to accommodate too much debris therein. Therefore, the user can save more labor while screwing. The present invention surely increases the user's convenience.
2. Continuing with the last point, while in operation, due to the user bestows less labor to the present invention than to the conventional screw, the screwing angle will be small and the user can easily hold the screwing tool and bestow the labor firmly. The screw hence will not rotate idly while it is screwed into the concrete object, then the problem of reaming and the screw broken will not happen. Therefore, the present invention can have the effect on screwing and can be fastened into the concrete object firmly.
3. Due to the non-continuous second threaded section, the debris can be accumulated therein, the present invention can be well screwed can be fastened into the concrete object firmly.
To sum up, the present invention makes use of the pitches of the first and second threaded section smaller than those of the conventional screw to increase the screwing; therefore, while in operation, the user can easily hold the screwing tool and can bestow the labor firmly, the screw hence can be avoided from inclining on one side and the problem of reaming can also be prevented. Furthermore, the debris from cutting is accumulated in the second threaded section, and said debris forms a series connection, the present invention hence can be well screwed and fastened into the concrete object. Therefore, the present invention can really achieve its purpose.

While we have shown and described the embodiment in accordance with the present invention, it should be clear to those skilled in the art that further embodiments may be made without departing from the scope of the present invention.

I claim:

1. A screw comprising:
a head;
a shank connecting to said head; and
a first threaded section and a second threaded section spirally disposed on the shank; wherein, the shank forms a drilling portion opposite to the head, and said two threaded sections both consist of a plurality of threads, and a valley is formed between each two adjacent thread; to be more specific, said first threaded section is disposed near said distal end and said second threaded section is disposed near said head, and said two threaded sections connect to each other; moreover, said first threaded section is a continuous threaded section, and said second threaded section is a non-continuous threaded section; still further, each said thread of said second threaded section has a convex area and a concave area interlaced, and each two adjacent valleys connect to each other through said concave area.

2. The screw as claimed in claim 1, wherein the corresponding concave areas of the threads of said second threaded section are combined to form an imaging line, and said imaging line is parallel to the central line of said shank.

3. The screw as claimed in claim 1, wherein the corresponding concave areas of the threads of said second threaded section are combined to form an imaging line, and said imaging line is inclined to the central line of said shank.

4. The screw as claimed in claim 1, wherein two grooves are respectively disposed beside said first threaded section and said second threaded section, and said two grooves connect to each other and spirally disposed on the shank.

5. The screw as claimed in claim 1, wherein each convex area forms an inclined surface to contact the adjacent concave area.
